(19) United States
(12) Patent Application Publication
(10) Pub. No.: US 2012/0090154 A1
(43) Pub. Date: Apr. 19, 2012

(54) MANUAL PORTABLE TOOL FOR STRAIGHTENING AND POSITIONING USED METAL CROWN CAPS ONTO MOUTHS OF BOTTLES

(76) Inventor: Vincenzo De Fazio, Mendicino (IT)

(21) Appl. No.: 13/378,987

(22) PCT Filed: Apr. 19, 2010
(86) PCT No.: PCT/IT10/00171

§ 371 Date: Dec. 16, 2011

(30) Foreign Application Priority Data
Jun. 23, 2009 (IT) CS2009A000011

(51) Int. Cl. B23P 11/00; B23Q 7/04

(52) U.S. Cl. 29/505; 29/283.5

(57) ABSTRACT

A manual portable tool and a process are described, for straightening and positioning used metal crown caps onto mouths of bottles, in order to airtightly and watertightly close the bottles again; the tool comprises a handgrip and a tubular element equipped with at least two slits and composed, on an internal surface, of a circular crown, adapted to house therein a used cap before placing it onto a bottle mouth; a circular toothing formed of projections and adapted to house therein the used cap when it is pressed onto the bottle mouth in order to straighten the corresponding teeth of the cap onto the bottle mouth; and a circular opening, smooth and free from teeth, adapted to house therein the used cap after it has been placed onto the bottle mouth and before removing the tool from the bottle mouth and leaving the cap onto the bottle mouth.

The present invention refers to a manual portable tool for straightening and positioning used metal crown caps onto mouths of bottles, and to a process for using such tool.

All manual or pneumatic plugging machines for metallic caps are devised to engage, onto a bottle mouth, a new, namely not used, cap.

The above machines are composed of a series of complex components that, in spite of their improvement, during the years, have not yet been able to plug a capsule deformed by its opening with a normal cap-opener.

From such inconvenience, it follows that the cap, once opened, cannot be used again. This implies that, in order to store the possible remaining liquid of a bottle, it is necessary to use another cap. The squashing with a bump exerted with the palm of a hand on the used crown-type metallic cap can be a good method to secure the used cap in order to prevent big-sized solid objects from entering the bottle, but does not guarantee the airtight and watertight seal of the bottle, that will be forced to be stored in a vertical position. This latter element, without the use of other types of caps, prevents from optimising the available space inside a refrigerator or any other container, since the bottled cannot be placed horizontally.

Therefore, object of the present invention is solving the above prior art problems, by providing a manual portable tool for straightening and positioning used metal crown caps onto mouths of bottles, so that the caps can be rest and airtightly and watertightly fastened onto a bottle mouth.

Another object of the present invention is providing a tool as described above, which is further equipped with an integrated cap-opener, in order to be able to perform both opening and closing of a cap without using other tools suitable to individually perform such operations.

Another object of the present invention is providing a process, which uses the above tool, for straightening and positioning used metal crown caps onto mouths of bottles.

The above and other objects and advantages of the invention, as will appear from the following description, are obtained with a manual portable tool for straightening and positioning used metal crown caps onto mouths of bottles as claimed in claim 1.

Preferred embodiments and non-trivial variations of the present invention are the subject matter of the dependent claims.

It will be immediately obvious that numerous variations and modifications (for example related to shape, sizes, arrangements and parts with equivalent functionality) can be made to what is described, without departing from the scope of the invention as appears from the enclosed claims.

The present invention will be better described by some preferred embodiments thereof, provided as a non-limiting example, with reference to the enclosed drawings, in which:

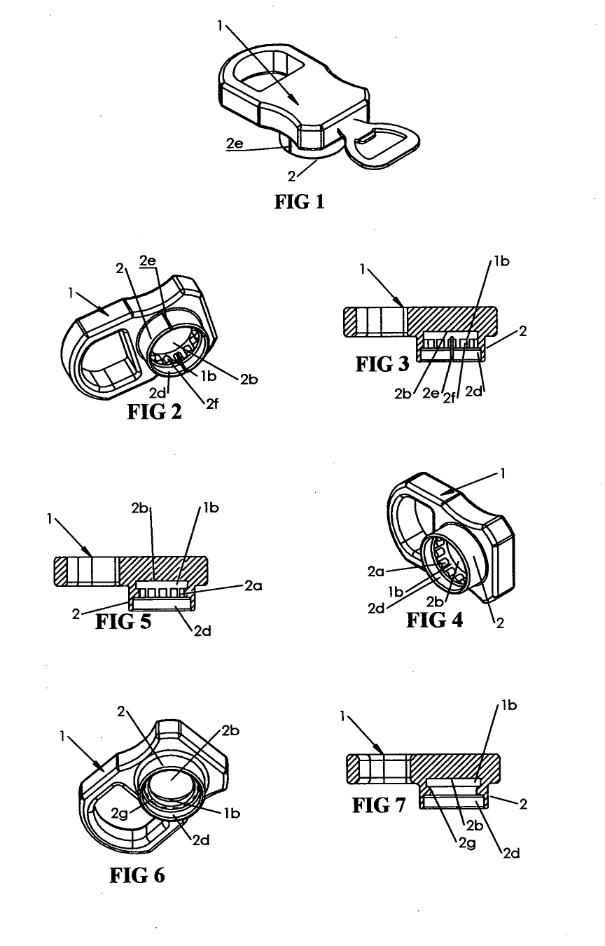

FIG. 1 is an axonometric view of the tool integrated with a normal cap-opener;

FIG. 2 is an axonometric view of the tool with teeth of a helical shape;

FIG. 3 is a section of the tool useful to point out the recess of the tubular element with helical teeth and slits;

FIG. 4 is an axonometric view of the tool with straight teeth of a semicylindrical shape;

FIG. 5 is a section of the tool useful to show the recess of the tubular member with straight teeth;

FIG. 6 is an axonometric view of the tool useful to point out the replacement of teeth with a single projection;

FIG. 7 is a section of the tool useful to show the recess of the tubular element with the single circular projection inside;

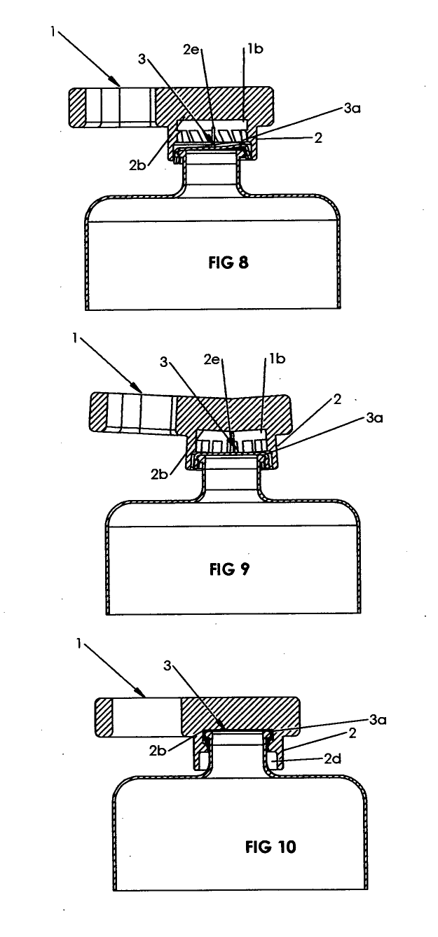

FIG. 8 is a section of the tool-cap-bottle assembly, useful to show the first step of the fastening process, where the cap deformation is pointed out;

FIG. 9 is a section of the tool-cap-bottle assembly, useful to show the step of deforming the tutular element when squashing the cap; and

FIG. 10 is a section of the tool-cap-bottle assembly, useful to show the last step of the fastening process, where fastening of the cap onto the bottle mouth is pointed out, when the tool has re-obtained its initial shape.

With reference to the Figures, a preferred embodiment is described of the manual portable tool of the invention, for straightening and positioning used metal crown caps 3 onto mouths of bottles, in order to airtightly and watertightly close the bottles again. Such tool comprises a handgrip 1 and a tubular element 2 placed on a bottom surface of the handgrip 1.

The tubular element 2 is composed, on an internal surface thereof, of the following components:

a circular crown 2d, smooth and free from teeth, adapted to house therein a used cap 3 before placing it onto a bottle mouth, the circular crown 2d having a first diameter;

a circular toothing 2a formed of projections 2a and arranged above the circular crown 2d, the circular toothing 2a having a second diameter which is smaller than the first diameter of the circular crown 2d; the circular toothing 2a is adapted to house therein the used cap 3 when it is pressed onto the bottle mouth in order to straighten the corresponding teeth of the cap 3 onto the bottle mouth; and

a circular opening 1b, smooth and free from teeth, arranged above the circular toothing 2a; the circular opening 1b has a third diameter which is greater that the second diameter of the circular toothing 2a and which is smaller than the first diameter of the circular crown 2d. The circular opening 1b is adapted to house therein the used cap 3 after it has been placed onto the bottle mouth and before removing the tool from the bottle mouth and leaving the cap 3 onto the bottle mouth.

The tubular element 2 is further equipped, on an external surface thereof, with at least one slit 2e (in the embodiment shown, the slits 2e are two) adapted to provide the tubular element 2 with more elasticity and to house therein corresponding burrs formed on the surface of the used cap 3, in order to enable to remove such burrs upon pressing the used cap 3 onto the bottle mouth.

The tubular element 2 has sufficient elasticity to be dilatated outwards when squashing the projections 2a of the circular toothing 2a onto the cap edge and to return to its starting position once the cap edge has been crossed by the projections 2a and has been placed in the circular opening 1b.

In particular, the circular toothing 2a is composed of helical teeth, whose number is equal to the projections on the cap edge.

Alternatively, the circular toothing 2a can be composed of straight teeth with a semicylindrical shape, whose shape and number are suitable to guarantee a squashing of all projections on the cap edge.

As other alternative, the circular toothing 2a can be composed of a single circular projection 2g.

Moreover, the manual portable tool of the invention can further comprise a cap-opener for metallic crown-type caps 3.

With the above tool, it is possible to perform a process for straightening and positioning used metal crown caps 3 onto mouths of bottles, in order to airtightly and watertightly close the bottles again, using a manual and portable tool as described above, where the process comprises the steps of:

placing a used cap inside the circular crown 2d, smooth and free from teeth;

placing the used cap 3 over a bottle mouth;

firstly pressing the used cap 3 onto the bottle mouth so that the used cap 3 is housed in the circular toothing 2a and gets in contact with the projections 2a of the circular toothing 2a in order to straighten the corresponding teeth of the cap 3 onto the bottle mouth;

secondly pressing the used cap 3 onto the bottle mouth so that the at least two slits 2e house therein the corresponding burrs formed on the surface of the used cap 3, in order to enable to remove such burrs upon secondly pressing the used cap 3 onto the bottle mouth;

housing the used cap 3 into the circular opening 1b after it has been placed onto the bottle mouth with all its burrs removed and its teeth gripping and airtightly and watertightly engaging the bottle mouth; and

removing the tool from the bottle mouth, at the same time leaving the cap 3 fastened onto the bottle mouth.

Summarising, as described above, the tool has the handle 1 on whose lower surface there is the tubular element 2 whose interior, at a certain depth, has a circular toothing formed of projections 2a, which are preferably semicylindrical, that end at a short distance from the base 2b of the tubular element 2. Therefore, between toothing and base 2b, an opening 1b is created on the internal surface of the tubular element 2.

The part 2d free from teeth of the element 2 performs three functions when using the tool: in fact, the above part is used to contain the cap 3, to place the cap 3 coaxially with respect to the bottle mouth and to remove possible excessive deformations being present on the crown of the cap 3, while the toothing with its projections 2a perform the function of squashing the cap crown in order to abut and fasten it onto the bottle neck and the opening 1b is used to house the edge 3a of the cap 3 at the end of the bottle closing operation.

The number of teeth must be at least equal to the number of projections being present on the crown knurling. If a smaller number of teeth has to be used, it will be necessary to size them with a geometry of an helical type 2f, so that, when squashing the crown, all crown projections are affected, or, alternatively, create a single projection 2g along the whole internal surface of the element 2.

It is clear that the tool is of a manual type and that, with the pressure that a user exerts on the tool, this latter one, with the element 2 placed axially with the bottle mouth and with the cap 3 placed onto the bottle neck, due to part 2b, will place again the cap 3 and, in case of excessive deformations of the cap 3 itself, the part 2d will make such deformations re-enter inside their own diameter (FIG. 8). The following pressure exerted by the user will allow the teeth 2a to adhere the cap crown onto the bottle neck due to the squashing that the teeth exert on the knurling existing on the cap crown. Such process is guaranteed in that the tubular element 2 is composed of materials that allow it to have a minimum elastic capacity that is able to contain the initial resistance that the edge 3a of the cap exerts onto the element 2 when squashing. The element 2 in this way will be able to be outwards dilatated (FIG. 9) and when the opening 1b, at the end of the operation, will house the cap edge, will free the teeth from the above resistance and consequent dilatation, allowing them, due to the elastic return effect, to further squash the crown onto the bottle neck (FIG. 10). The cycle ends when the base 2b of the tubular element 2 will press onto the upper surface of the cap 3, and the tool will be manually extracted from the bottle neck. The two slits 2e can, among others, increase the elasticity of the element 2, in addition to remove possible burrs forming onto the used cap 3.

1. A manual portable tool for straightening and positioning used metal crown caps onto mouths of bottles, in order to close the bottles in an airtight and watertight manner again, comprising a handgrip and a tubular element placed on a bottom surface of said handgrip, wherein:
the tubular element comprises, on an internal surface thereof, the following components:
a circular crown, namely, a circular recess, smooth and free from teeth, adapted to house therein a used cap before placing the used cap onto a bottle mouth, the circular crown comprising a first diameter;
a circular toothing formed of at least one projection and arranged above the circular crown, the circular toothing comprising a second diameter which is smaller than the first diameter of the circular crown, the circular toothing being adapted to house therein the used cap when it is pressed onto the bottle mouth in order to straighten the corresponding teeth of the cap onto the bottle mouth; and
a circular opening, smooth and free from teeth, arranged above the circular toothing, the circular opening comprising a third diameter which is greater than the second diameter of the circular toothing and which is smaller than the first diameter of the circular crown, the circular opening being adapted to house therein the used cap after the used cap has been placed onto the bottle mouth and before removing the tool from the bottle mouth and leaving the cap onto the bottle mouth; and
the tubular element further comprises, on an external surface thereof, at least one slit adapted to provide the tubular element with more elasticity and to house therein corresponding burrs, namely, surface discontinuities, formed on the surface of the used cap, in order to enable the removal of the burrs upon pressing the used cap onto the bottle mouth.

2. The manual portable tool according to claim 1, wherein the slits are two, mutually arranged along the circumference of the tubular element.

3. The manual portable tool according to claim 1, wherein the tubular element has such elasticity as to be dilatated outwards when squashing the projections of the circular toothing onto the cap edge and to return to a starting position of the tubular element once the cap edge has been crossed by the projections and has been placed in the circular opening.

4. The manual portable tool according to claim 1, wherein the circular toothing comprises helical teeth, whose number is equal to the projections on the cap edge.

5. The manual portable tool according to claim 1, wherein the circular toothing comprises straight teeth with a semicylindrical shape, whose shape and number are suitable to guarantee a squashing of all projections on the cap edge.

6. The manual portable tool according to claim 1, wherein the circular toothing comprises a single circular projection.

7. The manual portable tool according to claim 1, wherein the tool further comprises a cap-opener for metallic crown-type caps.

8. A process for straightening and positioning used metal crown caps onto mouths of bottles, in order to close the bottles in an airtight and watertight manner again, using a manual and portable tool according to claim 1, the process comprising the steps of:
placing a used cap inside the circular crown, smooth and free from teeth;
placing the used cap over a bottle mouth;
firstly pressing the used cap onto the bottle mouth so that the used cap is housed in the circular toothing and gets in contact with the projections of the circular toothing in order to straighten the corresponding teeth of the cap onto the bottle mouth;
secondly pressing the used cap onto the bottle mouth so that the at least one slit houses therein the corresponding burrs formed on the surface of the used cap, in order to enable the removal of the burrs upon secondly pressing the used cap onto the bottle mouth;
housing the used cap into the circular opening after the used cap has been placed onto the bottle mouth with all the burrs of the used cap removed and its teeth gripping and engaging the bottle mouth in an airtight and watertight manner; and
removing the tool from the bottle mouth, at the same time leaving the cap fastened onto the bottle mouth.
